(19) United States
(12) Patent Application Publication
(10) Pub. No.: US 2008/0057473 A1
(43) Pub. Date: Mar. 6, 2008

(54) Dental implant screw system

(76) Inventor: Dan Rosen, Calabasas, CA (US)

Correspondence Address: EDWIN TARVER, 16830 Ventura Blvd., SUITE 360, Encino, CA, 91436, US

(21) Appl. No.: 11/514,707

(22) Filed: Sep. 2, 2006

(51) Int. Cl. A61C 8/00

(52) U.S. Cl. 433/173

(57) ABSTRACT

A dental implant assembly comprising; a hollow first part on which an artificial tooth is affixed, a second part configured for receiving a threaded fastening means with a head portion and a threaded portion for connecting and securing the first and second parts; the head portion of the fastening means characterized by a predetermined profile, such that upon affixing the fastening means into the first and second part, the sides of the head portion make complete contact with the inside of the first part, preventing the threaded portion of the fastening means from moving during mastication.

### CROSS-REFERENCE TO RELATED APPPLICATION

None

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates generally to dental prosthetics, more specifically to dental implants, and more specifically to a dental post screw having a conical head, and a support post having hollow countersink to hold the screw.

Frequently, screws installed in connection with dental prosthesis break, causing serious problems by damaging both the fixture and the prosthesis. A screw fracture is usually caused by abnormal stresses produced by the prosthesis. Fractures are often the result of loosening of the screws that hold the implants in position.

Dental implant screws loosen due to repetitive stress forces caused by mastication. Imperceptible movement and micro-oscillations caused by masticating forces can eventually cause significant movement in the threading of the screw inside an implant. This action is common to virtually all fixation screws used in dental implants.

U.S. Pat. No. 6,152,737 to Beaty discloses a support post for use with a dental implant for supporting prosthesis. The problem with this system is that the screw, which connects the support post to the dental implant, is held at the shoulder region of the support post. Therefore the surface area in contact between the screw and the support post is substantially reduced; resulting in friction between the screw and the support post which eventually leads to loosening of the screw. Furthermore, in this invention the screw head does not have any contact with the implant. Therefore, when pressure is exerted on the screw head, it extends to the thread and bore area, causing damage to the screw threads that may eventually lead to a screw fracture.

U.S. Pat. No. 7,090,495 to Rosen discloses a dental implant screw and post system, comprising first and second parts that interlock to prevent loosening of the implant. Although this device uses a mechanism similar to the present invention, the first and second parts only function when installed together, since the screw head contacts both the implant, and the post, and may only be used when initially installing an implant. By contrast, the present invention contemplates an improved screw system to be used in connection with conventional posts that have already been implanted in a user, have malfunctioned, and need to be replaced, or that can be used in initial implantation with a traditional implant device.

Therefore, there is a need for a dental implant and screw that exerts torque and pressure evenly to prevent loosening and fracturing of the screw and implant, which can be used in connection with typical dental implants as are currently used in the art.

In view of the foregoing disadvantages inherent in the above-mentioned techniques, a general object of the present invention is to obviate above and other drawbacks associated with the prior art; to provide a system for an implant which can evenly bear the pressure exerted; to provide an improved assembly; to provide a screw with conical head which bears all the pressure thus preventing from the implant from fixture.

Other objects of the present invention are to provide a support post with an improved design which houses the screw conical head of the screw providing better holding and reducing the chances of under threading; to provide an improved implant with a conical passage to partially hold the conical head of the screw; and to hold the support post and implant firmly to prevent vertical circular motion of the support post over the implant. These and other objects of the present invention will become better understood with reference to the appended Summary, Description and Claims.

### SUMMARY

A dental implant assembly comprising a post on which an artificial tooth is affixed, a second part configured for receiving a threaded fastening means. The said fastening means, which can be a screw having a head portion and a threaded portion for fastening said first and second parts.

A locking mechanism provided with both first and second parts by means of male-female locking mechanism that prevents rotational motion once they are affixed together.

The post comprises a hollow tubular member with an interior side and an exterior side; an anterior end on which an artificial tooth is affixed, and a posterior end that attaches to the second part. The interior posterior end of the post has a slanted profile, such that the diameter of the interior side is uniformly reduced toward the posterior end, where the diameter is smallest. This results in a three-dimensional conical shape in the interior posterior end of the post.

Corresponding to the shape of the interior side of the post, the head portion of the screw comprises sides that have a complementary slanted profile, resulting in a complimentary conical shape, so that the side the head portion of the screw comes into complete contact with the interior of the post.

In other preferred embodiments of the invention, the posterior interior of the post may comprise a three dimensional shape other than conical, as long as the sides of the head portion of the screw comprise a complimentary shape, and the shape is larger in dimension at the top of the head portion of the screw, and smaller in dimension at the junction of the head portion and the threaded portion of the screw.

### BRIEF DESCRIPTION OF THE DRAWINGS

FIG. 1 is a side view of the screw with a conical head portion, in a preferred embodiment of the present invention.

FIG. 2 is a cut-away side view of the post of the dental implant assembly.

FIG. 3 is a cut-away side view of the post of the dental implant assembly, with the screw installed in the post.

FIG. 4 is a cut-away side view of the post and second part of the dental assembly, with the screw installed, affixing the parts together.

FIG. 5 is three dimensional profile view of the screw, post, and second part of the dental implant assembly.

FIG. 6 is is a cut away view of the dental implant assembly installed in the tooth of a user.

### REFERENCE NUMERALS

3. . . . Tooth
9. . . . Jaw
19. . . . Screw
21. . . . Conical Shaped Screw Head Portion
23. . . . Threaded Portion
25. . . . Post
27. . . . Post Interior
29. . . . Post Interior Posterior Conical Section
31. . . . Post Posterior End Receiving Means
33. . . . Second Part

### DETAILED DESCRIPTION

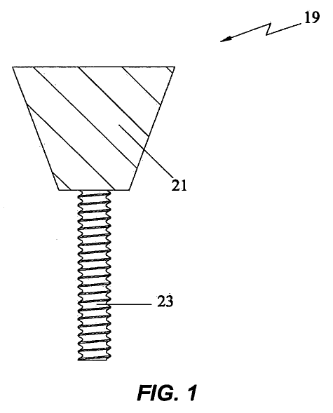

Referring to the illustrations, FIG. 1 is a side view of the screw of a preferred embodiment of the present invention. The screw 19 comprises two sections, a conical shaped screw head portion 21 and a threaded portion 23. The threaded portion 23 engages a dental implant, while the conical section engages a post for an artificial tooth.

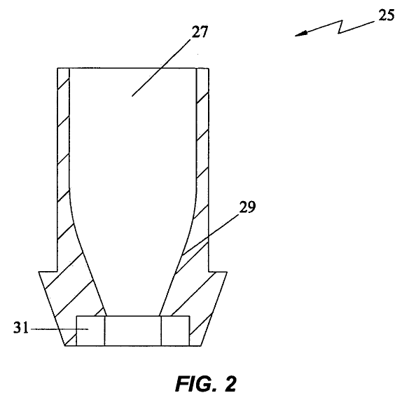

FIG. 2 is an illustration of the post of a preferred embodiment of the present invention. The post 25 comprises a hollow structure with an interior 27 area. The interior of the post 25 comprises a columnar space with a diameter that is smaller at the posterior end than at the other, such that the interior 27 posterior area comprises a conical shape 29 for receiving the screw 19. The post 25 also comprises a receiving means 31 at its posterior end for engaging a dental implant.

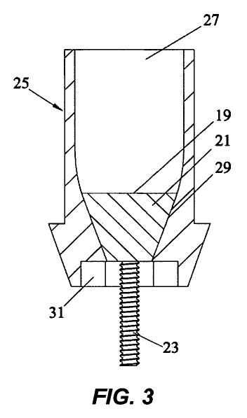

FIG. 3 is an illustration of the screw 19 positioned in the post 25. When the screw 19 is in place, the bottom of the conical section 29 is flush with the junction of the post 25 and a dental implant, and the sides of the head of the screw 19 are in uniform and complete contact with the interior conical section 29 of the post 15. In this manner, the screw is prevented from making any movement other than rotational when engaging a dental implant, which prevents the screw from loosening when installed, thereby preventing fractures of the screw.

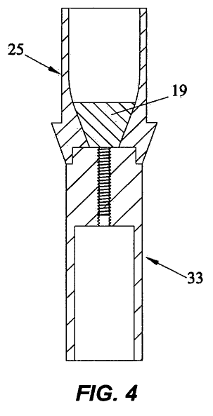

FIG. 4 shows an installed dental assembly of a preferred embodiment of the present invention. The post 25 receives the implant 33 in the posterior end, adjacent to the conical section 29, and the screw 19 is inserted into the interior of the post 27. Thereafter, the screw is tightened into a threaded bore contained in the implant, affixing the post to the implant. Once the screw is tightened, the conical section of the head portion of the screw 21 abuts the interior conical section of the post 29, and is prevented from any further movement.

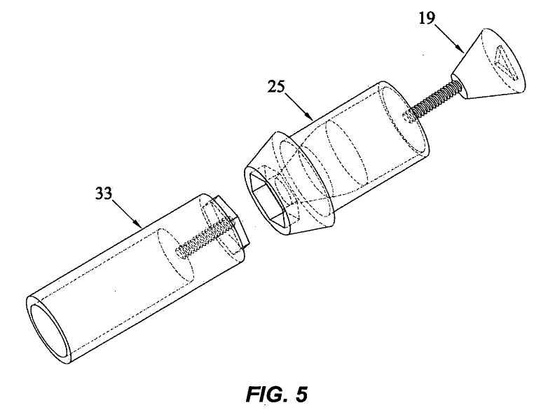

FIG. 5 is an illustration of a perspective view of a dental implant in accordance with a preferred embodiment of the present invention. The screw 19 fits into the post interior 27, and engages a threaded bore in the dental implant 33. When the screw is tightened in the post 25, the side of the head portion of the screw 21 is in complete contact with the post interior 27 and the screw threads 23 are in complete contact with the implant 33.

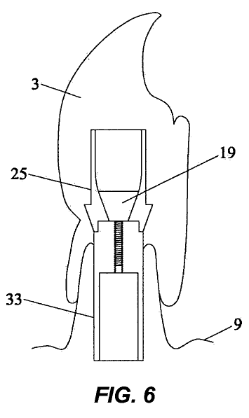

FIG. 6 is a side view illustration of a preferred embodiment of the dental implant of the present invention as installed in the mouth of a user. Once the implant 33 is affixed in the jaw of a user, the post 25 and screw 19 are affixed to the implant by placing the post 25 over the implant 22, inserting the screw into the post 25 and tightening the screw 19 into the implant 33, so that the side portion of the head of the screw 19 is in complete contact with the interior of the post 25. Once the screw 19 is tightened, the unique shape of the head prevents any further movement of the screw 19 due to lateral masticating forces applied on the tooth.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A dental screw and post system, comprising:
a. a screw, comprised of a threaded member extending from a head portion; the head portion comprised of a top for receiving and engaging a tightening device, and one or more sides extending from the edges of the top portion to the threads of the screw; and
b. a post for receiving the screw, wherein when the screw is tightened in connection with the post, the side of the head portion of the screw comes into uniform contact with the post.

2. The dental screw and post system of claim 1, wherein the side extending from the edges of the top portion to the threads of the screw comprises a conical shape.

3. The dental screw and post system of claim 1, wherein the post comprises a hollow tube shaped member,

4. The dental screw and post system of claim 3, wherein the hollow inner portion of the post is adapted on one side to conform to the sides of the screw.

5. The dental screw and post system of claim 1, wherein the threads of the screw meet the head of the screw at the junction of the post and an implant on which the post is secured.

6. The dental screw and post system of claim 1, wherein the fastening means is any fastening means including screws.

7. A dental implant assembly as claimed in claim 1 wherein said the profile of the head portion of the screw is a slanted profile.

8. A dental implant assembly comprising;
a. a hollow first part with an inner side and an outer side on which an artificial tooth is affixed;
b. a second part configured for implantation in the jaw of a user, and for receiving a threaded fastening means; and
c. a fastening means having a head portion with a top and at least one side, and a threaded portion for fastening the first and second parts, wherein the head portion of the fastening means has a predetermined profile such that upon installing the fastening means into the first and second parts, the side of the head portion makes complete contact with the inner side of the first part and terminates at the junction of the first and second parts.
